(19) United States
(12) Patent Application Publication
(10) Pub. No.: US 2009/0055806 A1
(43) Pub. Date: Feb. 26, 2009

(54) Techniques for Employing Aspect Advice Based on an Object State

(76) Inventor: Jian Tang, Rochester, MN (US)

Correspondence Address: IBM CORPORATION, 3605 HIGHWAY 52 NORTH, DEPT 917, ROCHESTER, MN, 55901-7829, US

(21) Appl. No.: 11/843,207

(22) Filed: Aug. 22, 2007

(51) Int. Cl. G06F 9/44

(52) U.S. Cl. 717/131

(57) ABSTRACT

A technique of employing advice with base code includes parsing an object state filter in an advice pointcut of the advice and generating a subroutine to evaluate whether an object state meets the object state filter. The subroutine, one or more bound aspect parameters, and an advice body of the advice is then weaved with the base code.

### BACKGROUND

1. Field

This disclosure relates generally to aspect advice and, more specifically to techniques for employing aspect advice based on an object state.

2. Related Art

In general, aspects are concerns in software development that crosscut a dominant decomposition. An aspect is used to alter the behavior of base code (i.e., a non-aspect part of a program) by applying advice (added code having additional behavior) at matching join points (points in the base code specified in a query called a pointcut construct that determines whether a given join point matches). Concerns are the primary criteria for decomposing software into smaller, more manageable and comprehensible parts that have meaning to a software engineer. Examples of concerns include: requirements; use cases; features; data structures; quality-of-service issues; variants; intellectual property boundaries; collaborations; patterns; and contracts. Concerns arise throughout the software lifecycle and may involve formal and informal artifacts of various kinds. Some concerns apply within individual artifacts, but many concerns span multiple artifacts and lifecycle phases. For example, a requirement concern defined in a requirements document usually spans the architecture, design, code, tests, and documentation that address the requirement.

In relationship to aspects, crosscutting refers to a symmetric relationship between representations of concerns. For example, if ‘A’ is a representation of one concern and ‘B’ is a representation of another concern, if ‘A’ crosscuts ‘B’, then ‘B’ also crosscuts ‘A’. Examples of crosscutting concerns include logging, security, and account processing. Concerns have both intension and extension. Intension embodies the meaning, or intent of a concern and may be expressed formally as a filter (e.g., query or predicate). Ideally, the intention is stable even as the software changes. The extension enumerates the software elements that pertain to the concern, which may evolve as the software evolves.

In general, aspect oriented programming (AOP) languages employ advice, which consists of a pointcut construct (hereinafter “pointcut”) and a body (which executes at join points the pointcut matches). A pointcut can be thought of as a predicate over dynamic join points. At a given dynamic join point, a pointcut may match or not match the join point at run-time. In this manner, a pointcut may dynamically expose run-time information to a piece of advice. In general, join points are programming language semantic elements with which aspects coordinate. A join point can, for example, represent: a call to a method (subroutine); an execution of a method; a field setting event; or an exception handling event.

Typically, AOP languages implement aspect behavior by weaving a hook into a join point shadow, which is a static projection of a join point onto program code. Weaving is the process of coordinating aspects and non-aspects (i.e., base code). In a language like AspectJ, one part of weaving is ensuring that advice executes at appropriate dynamic join points. Weaving can be done explicitly or implicitly, and can be done at a variety of times. In static weaving, the weaving is performed at compile time which is similar to static in-lining of method bodies and results in the compiled code (advised by the aspect) directly containing instructions to run applicable advice. In contrast, in dynamic weaving, weaving is performed at load time. In dynamic weaving, a virtual machine or interpreter is typically aware of aspects and controls the weaving process.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of an example computer system that may be configured to employ advice with base code, according to various embodiments of the present disclosure.

FIG. 2 is a flowchart of an example process for employing advice with base code using the system of FIG. 1, according to one embodiment of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer readable storage medium may be, for example, but is not limited to, an electronic, magnetic, optical, electromagnetic, infrared, or semiconductor system, apparatus, or device. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. Note that the computer-usable or computer readable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer readable storage medium may be any medium that can contain, or store a program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single computer, on multiple computers that may be remote from each other, or as a stand-alone software package. When multiple computers are employed, one computer may be connected to another computer through a local area network (LAN) or a wide area network (WAN), or the connection may be, for example, through the Internet using an Internet service provider (ISP).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. As used herein, the term “coupled” includes both a direct electrical connection between blocks or components and an indirect electrical connection between blocks or components achieved using intervening blocks or components.

According to various aspects of the present disclosure, advice is applied based on an object state that is derived from parsing an object state filter, e.g., a where condition filter, of an advice pointcut and generating a subroutine to evaluate whether the object state meets the object state filter. Applying advice based on an object state readily facilitates separation of base code, advice, and state matching, which generally increases program modularity as conditional checks are not required to be directly added to aspect. Increasing program modularity is particularly advantageous with languages, such as java, that treat objects as entities that have inter-relationships with other entities and sub-entities. Using the disclosed techniques, state matching of entities and sub-entities may be readily achieved by parsing advice pointcuts.

According to one aspect of the present disclosure, a technique of employing advice with base code includes parsing an object state filter, e.g., a where condition filter, in an advice pointcut of the advice and generating a subroutine to evaluate whether an object state meets the object state filter. The subroutine, one or more bound aspect parameters, and an advice body of the advice is then weaved with the base code.

According to another aspect of the present disclosure, a computer readable storage medium includes: first code for parsing a query syntax of an advice pointcut; second code for generating a subroutine to evaluate whether an object state meets a condition of the query syntax; and third code for weaving the subroutine, one or more bound aspect parameters, and an advice body with the base code.

According to another aspect of the present disclosure, a computer system is disclosed that includes a processor and a memory subsystem coupled to the processor. The memory subsystem stores first code that when executed by the processor causes the processor to parse an object state filter, e.g., a where condition filter, in an advice pointcut and generate a subroutine to evaluate whether an object state meets the object state filter. The first code, when executed by the processor, also causes the processor to weave the subroutine, one or more bound aspect parameters, and an advice body with base code at each matched advice join point.

According to various aspects of the present disclosure, one or more parameter bindings are weaved in the aspect for each join point. In this case, before the advice is called, a subroutine (e.g., checkObjectState_X(Object)) is called to evaluate a condition associated with the subroutine. If the condition is satisfied, the advice is called. If the condition is not satisfied, the advice is skipped. In the example code set forth below, at compile time a routine checkObjectState_{—}1(Customer) is generated to check whether this customer is a “VIP” type and has made ten orders. A weaver is employed that weaves the base code, the checkObjectState_{—}1(this) code, and the advice together as is set forth in the example below:

```
void charge(Order order) {
        // Generated code starts
        // insert pointcut state evaluation
        boolean evaluated = checkObjectState_1(this);
            // insert advices here
            if (evaluated) {
              // apply 10% discount to the order
              order.discount = 0.1;
              order.amount *= (1−order.discount);
        }
        // Generated code ends
        histories.add(order);
        account.withdraw(order.getAmount( ));
    }
    /**
    * Generated code
* ?1 = ”VIP”
* ?2 = 10
*/
    private boolean checkObjectState_1(Customer customer) {
        if (customer.type==”VIP” && customer.orders.size( ) >10)
                return true;
        else
                return false;
    }
```

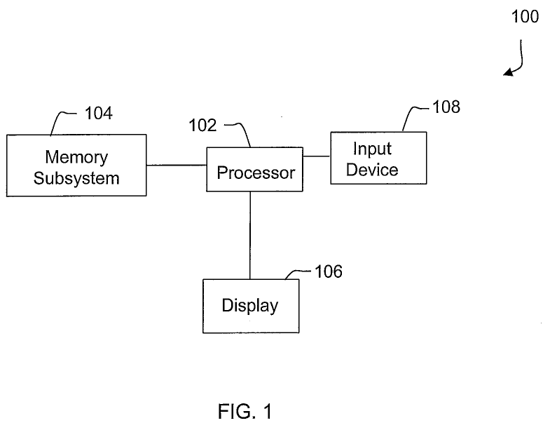

With reference to FIG. 1, an example computer system 100 is illustrated that may be configured to employ advice with base code according to various embodiments of the present disclosure. The computer system 100 may be utilized, for example, by a computer programmer that is attempting to troubleshoot base code operation. The computer system 100 includes a processor 102 that is coupled to a memory subsystem 104, a display 106, and an input device 108. The memory subsystem 104 normally includes an application appropriate amount of volatile memory (e.g., dynamic random access memory (DRAM)) and non-volatile memory (e.g., read-only memory (ROM)). The display 106 may be, for example, a cathode ray tube (CRT) or a liquid crystal display (LCD). The input device 108 may include, for example, a mouse and a keyboard. The processor 102 may also be coupled to one or more mass storage devices, e.g., a compact disc read-only memory (CD-ROM) drive.

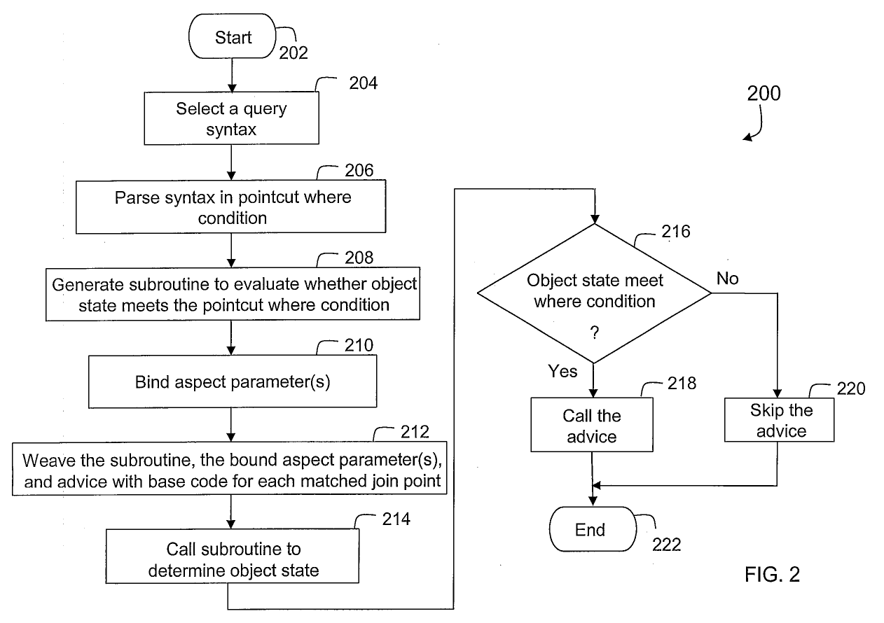

Moving to FIG. 2, an example process 200 for employing advice with base code, according to various aspects of the present disclosure, is illustrated. In block 202, the process 200 is initiated at which point control transfers to block 204. In block 204, a query syntax is selected for the advice pointcut. The query syntax may, for example, be based on a Backus Naur Form metasyntax. Next, in block 206, the syntax in the advice pointcut where condition is parsed. Then, in block 208, a subroutine (method) is generated to evaluate whether an object state meets the pointcut where condition. Next, in block 210, one or more aspect parameters are bound. The aspect parameters may be bound using, for example, a configuration file that includes one or more binding entries. In this case, each entry may include an aspect name, one or more matched pointcuts, and one or more parameter values. For example, an extensible markup language (XML) binding implementation may take the following form:

```
<aspect name=”DiscountForReturningCustomers”>
        <matchedJoinPoints>
<pointcut value=”before ( ):execution(*Customer.charge(Order))”/>
        <matchedJoinPoints>
            <paramBindings>
    <param value=”VIP” type=”java.lang.String”>
        <param value=”10” type=”int”>
            <paramBindings>
                </aspect>
```

In the example above, a first parameter is assigned the string “VIP” and a second parameter is assigned the integer value of “10.” It should be appreciated that the parameter bindings may achieved in other manners.

Following binding of the aspect parameters in block 210, control transfers to block 212, where the subroutine, the bound aspect parameters, and the advice are weaved with the base code for each matched join point. Then, in block 214, when the program is executed, the subroutine (e.g., checkObjectState_{—}1(this) in the example above) is called to determine the object state. Next, in decision block 216, it is determined whether the object state meets the where condition. If the object state meets the where condition, control transfers from block 216 to block 218, where the advice is called. If the object state does not meet the where condition in block 216, control transfers to block 220, where the advice is skipped. Following blocks 218 and 220, control transfers to block 222 where the process 200 returns to a calling process.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of employing advice with base code, comprising:
parsing an object state filter of an advice pointcut of the advice;
generating a subroutine to evaluate whether an object state meets the object state filter; and
weaving the subroutine, one or more bound aspect parameters, and an advice body of the advice with the base code.

2. The method of claim 1, further comprising:
calling the subroutine to determine the object state.

3. The method of claim 2, further comprising:
calling the advice body when the object state meets the object state filter; and
skipping the advice body when the object state does not meet the object state filter.

4. The method of claim 1, further comprising:
binding, using a configuration file, one or more aspect parameters to respective selected values to provide the one or more bound aspect parameters.

5. The method of claim 1, wherein the object state filter is a query syntax and the parsing further comprises:
parsing the query syntax in the object state filter of the advice pointcut of the advice, wherein the query syntax is based on a Backus Naur Form metasyntax.

6. The method of claim 1, wherein the weaving further comprises:
weaving the subroutine, the one or more bound aspect parameters, and the advice body of the advice with the base code at each matched join point.

7. The method of claim 1, further comprising:
replacing the advice pointcut with a pointcut evaluation statement that calls the subroutine.

8. The method of claim 1, wherein the weaving further comprises:
statically weaving the subroutine, the one or more bound aspect parameters, and the advice body of the advice with the base code at each matched join point during compilation.

9. The method of claim 1, wherein the weaving further comprises:
dynamically weaving the subroutine, the one or more bound aspect parameters, and the advice body of the advice with the base code at each matched join point at run-time.

10. A computer readable storage medium, comprising:
first code for parsing a query syntax of an advice pointcut;
second code for generating a subroutine to evaluate whether an object state meets a condition of the query syntax; and
third code for weaving the subroutine, one or more bound aspect parameters, and an advice body of the advice with the base code.

11. The computer readable storage medium of claim 10, further comprising:
fourth code for calling the subroutine to determine the object state.

12. The computer readable storage medium of claim 11, further comprising:
fifth code for calling the advice body when the object state meets the condition and skipping the advice body when the object state does not meet the condition.

13. The computer readable storage medium of claim 12, further comprising:
sixth code for binding, using a configuration file, one or more aspect parameters to respective selected values to provide the one or more bound aspect parameters.

14. The computer readable storage medium of claim 13, wherein the third code for weaving further comprises:
seventh code for weaving the subroutine, the one or more bound aspect parameters, and the advice body of the advice with the base code at each matched join point.

15. The computer readable storage medium of claim 15, further comprising:
eighth code for replacing the advice pointcut with a pointcut evaluation statement that calls the subroutine.

16. The computer readable storage medium of claim 10, wherein the third code for weaving further comprises:
ninth code for statically weaving the subroutine, the one or more bound aspect parameters, and the advice body of the advice with the base code at each matched join point during compilation.

17. The computer readable storage medium of claim 10, wherein the third code for weaving further comprises:
tenth code for dynamically weaving the subroutine, the one or more bound aspect parameters, and the advice body of the advice with the base code at each matched join point at run-time.

18. A computer system, comprising:
a processor; and
a memory subsystem coupled to the processor, wherein the memory subsystem stores first code that when executed by the processor causes the processor to:
parse an object state filter in an advice pointcut;
generate a subroutine to evaluate whether an object state meets the object state filter; and
weave the subroutine, one or more bound aspect parameters, and an advice body with base code at each matched advice join point.

19. The computer system of claim 18, wherein the memory subsystem stores second code that when executed by the processor causes the processor to:
replace the advice pointcut with a pointcut evaluation statement that is configured to call the subroutine when executed.

20. The computer system of claim 18, wherein the memory subsystem stores third code that when executed by the processor causes the processor to:
bind one or more aspect parameters to respective selected values to provide the one or more bound aspect parameters.
